(19) United States
(12) Patent Application Publication
(10) Pub. No.: US 2025/0115474 A1
(43) Pub. Date: Apr. 10, 2025

(54) METHODS AND DEVICES FOR THE PRODUCTION OF HYDROGEN USING PLASMA ENERGY WITHIN A SUPERCRITICAL FLUID

(71) Applicant: James Khreibani, Miami Beach, FL (US)

(72) Inventor: James Khreibani, Miami Beach, FL (US)

(73) Assignee: James Khreibani, Miami Beach, FL (US)

(21) Appl. No.: 18/906,233

(22) Filed: Oct. 4, 2024

Related U.S. Application Data
(60) Provisional application No. 63/542,494, filed on Oct. 4, 2023.

(51) Int. Cl. C01B 3/02

(52) U.S. Cl. CPC C01B 3/02; C01B 2203/0272; C01B 2203/041; C01B 2203/0861

(57) ABSTRACT

The invention provides a novel method for producing green hydrogen through the interaction of supercritical fluids with plasma technology. This method involves creating a supercritical fluid through pressurizing and heating a fluid that contain hydrogen molecules within a reactor, facilitating the efficient dissociation of molecular bonds in the fluid. When supercritical the hydrogen bonds weaken, enhancing the reaction kinetics and improving hydrogen yield. Electricity at is passed through electrodes at the required voltage and amps needed to produce a plasma within the specific fluid. By carefully controlling parameters such as pressure, temperature, and plasma characteristics, the process optimizes the conversion of the supercritical fluid into hydrogen and other valuable by-products. This innovative approach not only increases hydrogen production efficiency when compared to alternative electrolysis approaches but also minimizes energy consumption and environmental impact, positioning the method as a sustainable solution for hydrogen generation.

### CROSS-REFERENCE TO RELATED APPLICATIONS

This patent application claims the priority date benefit of provisional patent application Ser. No. 63/542,494, filed 4 Oct. 2023 by the present inventor, which is incorporated herein in its entirety by reference.

### FIELD OF THE INVENTION

Without limiting the scope of the invention, its background is described in connection with methods and devices to produce hydrogen from supercritical fluids using plasma energy to split hydrogen from other molecules within an enclosed vessel.

### BACKGROUND OF THE INVENTION

The need for hydrogen as an energy source has become increasingly evident, considering the well-known facts regarding the exploration and production of fossil fuels. Global oil reserves are finite and depleting rapidly. Despite this awareness of finite reserves, the demand for oil continues to rise due to escalating energy needs both domestically and globally. As a result, oil prices are expected to keep climbing as known reserves dwindle, ultimately leading to exorbitantly priced energy that could trigger severe economic contractions worldwide.

Perhaps the most pressing concern associated with fossil fuels is their environmental impact. The combustion of fossil fuels releases carbon dioxide (CO₂) and smog-forming compounds into the atmosphere, contributing to global warming and associated climatic changes. These changes, such as rising global temperatures and sea levels, pose serious threats, including the loss of arable land needed for food production and the melting of polar ice caps. Consequently, there is a growing urgency to transition to cleaner and more sustainable energy sources.

Furthermore, most existing hydrocarbon reserves are in politically unstable regions. This geopolitical instability poses a significant risk, as hostile governments or cartels could exploit their oil resources to hold industrialized nations hostage through oil export embargoes or exorbitant pricing. The potential for sudden disruptions in oil production or price fluctuations due to such hostilities has been forecasted to cause profound economic upheavals in society. Given these challenges, it is imperative that we shift our focus toward energy sources that are abundant, renewable, and readily available.

Carbon-free hydrogen emerges as a compelling solution in this context. It is both abundant and renewable, containing three times more energy per unit weight than gasoline. Several methods for hydrogen production exist, including coal gasification, partial oil oxidation, steam methane reforming, electrolysis, biomass gasification, and, lately, plasma cracking. However, a significant drawback of these methods is the co-production of carbon dioxide, a leading contributor to global warming, and the cost associated with the greener alternatives.

Despite the cost, the electrolysis of water stands out as the most viable alternative and is gaining rapid traction as the globe attempts to decarbonize its energy supply. This process can yield high-purity hydrogen and oxygen without generating carbon dioxide as a byproduct. Nevertheless, a notable limitation is the substantial electrical power required to split water into its constituent elements, hydrogen, and oxygen. Various factors within the electrolysis process contribute to these high-power requirements, such as the high dielectric constant of water, mass transfer resistance at electrodes, and constraints related to electrode surface area.

Plasma hydrogen production is a method that involves using a high-energy plasma, generated by high voltages, radio-frequency, microwaves, or high-energy photon discharge to ionize and break down gases and liquids like methane or water vapor into their constituent atoms and ions. These atoms and ions can then be recombined to form hydrogen gas. Plasma hydrogen production can operate at relatively low temperatures and pressures and is adaptable to a wide range of feedstocks, making it versatile and potentially cost-effective.

In contrast, electrolysis, a fundamentally different hydrogen production method, relies on using an electric current to split water molecules into hydrogen and oxygen, requiring a suitable electrolyte and a source of electricity. The hydrogen gas produced through electrolysis is collected and purified for use. While electrolysis has been widely established and used, plasma hydrogen production, a fundamentally different process, offers an alternative approach but has been limited by high cost. There remains a need in the art to reduce the cost of hydrogen production through plasma.

### SUMMARY OF THE INVENTION

The present invention is based on using a supercritical fluid (SCF). In general terms, a supercritical fluid is a distinct state of matter that emerges when a substance is subjected to specific temperature and pressure conditions, known as its critical point. In this unique state, the substance exhibits a combination of properties from both gases and liquids. Supercritical fluids have densities intermediate between gases and liquids and are highly compressible. They possess exceptional solvency and mixing capabilities, making them invaluable for processes like extracting essential oils or separating chemicals. These fluids have rapid diffusion rates, facilitating efficient mass transfer, and their properties can be tuned by adjusting temperature and pressure. Notably, they lack a distinct meniscus or surface tension, behaving more like gases in terms of fluidity. Supercritical fluids, such as carbon dioxide and water, are known for their environmental friendliness and find wide-ranging applications across industries, from pharmaceuticals to food processing and materials science.

This patent discloses a new process that uses plasma energy to split a hydrogen-containing supercritical fluid into hydrogen atoms and molecules, commonly known as hydrogen. The supercritical fluids that contain hydrogen within its molecular structure are conveyed through a nozzle where the concentrated plasma energy splits the molecule into at least one part of hydrogen. The hydrogen and the remaining non-hydrogen products contact a filter that allows the hydrogen to defuse through and prevents the non-hydrogen products from migrating through the filter's substrate. Once the hydrogen is separated from the non-hydrogen products, it is diverted from the process. The non-hydrogen molecules are diverted from the process separately and discharged or recirculated back through the reactor, where the process repeats itself.

### BRIEF DESCRIPTION OF THE DRAWINGS

The various embodiments of this disclosure will be better understood by referring to the following detailed description and the accompanying drawings, which illustrate the disclosed configurations.

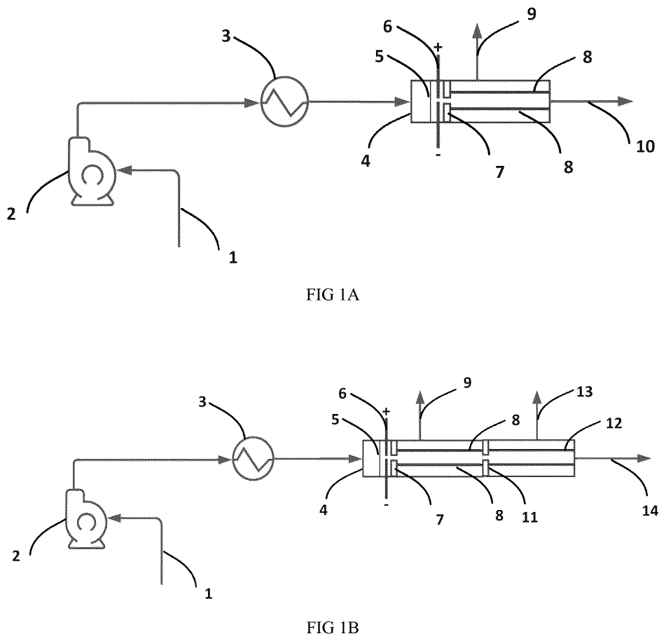

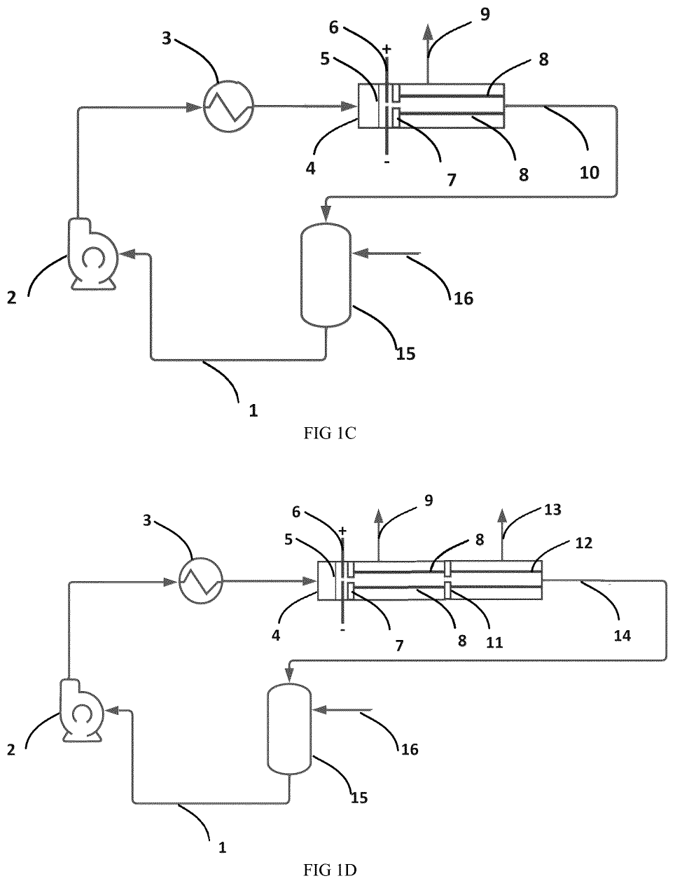

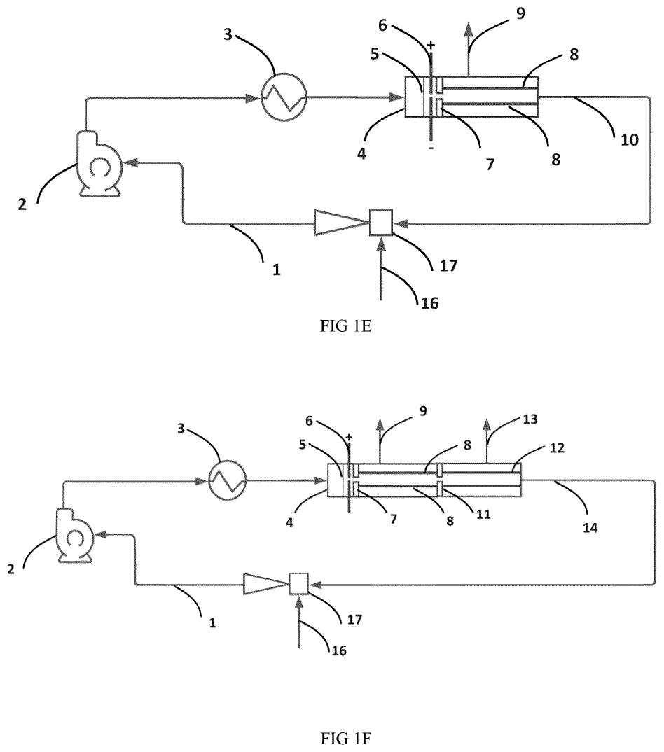

a) FIG. 1A to 1F show flow diagrams schematically illustrating the use of Supercritical Fluid, pressure, and separators to produce a substantially pure soluble compound. The reference numerals represent the following:

1 Inlet Stream
2 Compression Device
3 Heat Exchanger
4 Reactor
5 Ceramic Electrode Isolator
6 Electrodes/High Energy source
7 First Stage Separator Inlet
8 First Molecular Sieve/Filter
9 First Stage Separated Fluid Discharge
10 First Stage Unseparated Discharge
11 Second Stage Separator Inlet
12 Second Molecular Sieve/Filter
13 Second Stage Separated Discharge
14 Second Stage Unseparated Discharge
15 Accumulator
16 Make-up Fluid
17 Ejector

### DETAILED DESCRIPTION OF THE DRAWINGS

Any substance above its critical temperature and pressure experiences a phase change into a Supercritical Fluid and exhibits properties between those of gases and liquids. It is well known in the art that unlike gasses, SCFs possess considerable solvent strength, and their transport properties are more favorable than liquid solvents due to their lower viscosity and increased diffusion coefficients. It is also well known in the art that the density of the SCF may be modified over a modest range with small variations in temperature and pressure. This tunability may be used to control the behavior within a separation process. Of the supercritical fluids, natural occurring supercritical water (SCW) is extremely uncommon due to its high temperature and pressure of 647 K and 22.1 MPa, respectively, and mostly present under supercritical conditions in the Earth's crust and mantle. Specifically related to SCW, it has recently become known (through Angew. Chem. Int. Ed. 2020, 59, 18578-18585 doi.org/10.1002/anie.202009640, incorporated herein in its entirety by reference) that the hindered translational motion of water molecules in supercritical conditions does not resemble the intermolecular H-bond stretching vibrations found in highly directional tetrahedral arrangements, as seen in ambient liquid water. Instead, it resembles the hindered translational motion observed in supercritical van der Waals fluids, which are not subject to directional H-bonding. This similarity leads to a conclusion that supercritical water can be accurately described using purely isotropic Lennard-Jones interactions, as demonstrated for the supercritical state. Ultimately, it is now understood that the combination of weak and the absence of hydrogen bonding is the fundamental reason why supercritical water behaves as a fundamentally different solvent compared to ambient liquid water, making the hydrogen atoms more readily separatable from the oxygen atoms and generally unknown to those ordinarily skilled in the art.

Additionally, the use of plasma, as disclosed in this invention, for separating hydrogen from other covalently bonded atoms in a supercritical fluid, such as in the case Hydrogen from Oxygen in SCW, has not been previously disclosed.

More specifically, one exemplary embodiment of this disclosure is shown in FIG. 1A, wherein an Inlet Stream 1 that may include water, methane, ethanol, or another fluid is conveyed through a pipe and enters a Compression Device 2 or plurality of Compression Devices 2 which may be a pump, a compressor, a turbine, or another device capable of increasing the pressure of the Inlet Stream 1 to above or around the fluid within the Inlet Streams 1 supercritical pressure. The Compression Device 2 discharge is conveyed through a pipe and enters the Heat Exchanger 3 or a plurality of Heat Exchangers 3, wherein the temperature is increased to above the fluid contained within the Inlet Stream 1 supercritical temperature. The Heat Exchanger 3 is defined as a method of raising the temperature of the Inlet Stream 1 and may be also considered a boiler, furnace, induction heater, water heater, or any other method that raises the temperature of a fluid. The Heat Exchanger 3 discharge is conveyed through a pipe and enters Reactor 4 or a plurality of Reactors 4. The Reactor 4 is a pressure vessel designed to withstand the pressures and temperatures required for the specific supercritical fluid discharged from the Heat Exchanger 3 and may be of any cross-section shape but generally circular and manufactured from a range of materials, including, for example, and without limitation to Steel, Stainless Steel, Inconel, Hastelloy, Plastic, Basalt, Ceramic or other material. The supercritical fluid within the Reactors 4 flows through the internal chamber or cavity within the Reactors 4, where it makes contact with a Ceramic Electrode Isolator 5 that contains a nozzle generally, for example, and without limitation, in the center of the Ceramic Electrode Isolator 5. The Ceramic Electrode Isolator 5 is generally made of ceramic material due to its ability to withstand high temperatures, electrically isolate the electrodes from Reactor 4, and low reactivity to supercritical fluids, however the Ceramic Electrical Isolator 5 may be of any material that can suitably perform under the required conditions. The supercritical fluid flows through the Ceramic Electrode Isolator 5, where it makes contact with an Electrodes/High Energy Source 6, where the necessary conditions to create plasma are provided. The Electrodes/High Energy Source 6 may comprise two electrodes, one positively charged (+), and one negatively charged (−), where high-intensity energy is transferred between the different polarities. The Electrodes/High Energy Source 6 may contain a plurality of sources all within the scope of this disclosure.

In the Electrodes/High Energy Source 6, the positive and negative electrodes will be positioned opposite each other, and both electrodes will be positioned through a hole through the cross-section of the Ceramic Electrode Isolator 5 and will terminate in the center of the ceramic disc's nozzle. At the center of the ceramic disc nozzle, the positive and negative electrodes will not touch and will have sufficient clearance that will allow the ionizing to occur due to current passing between the electrodes under high voltage and high alternating frequency.

Although there are various theories to describe the production of plasma by way of example and without limitation, one way to describe the production of plasma may be as follows. The ionization of a fluid by high-voltage plasma takes several steps, starting when a high voltage is applied across a fluid gap between two oppositely charged electrodes. The exact voltage and frequency that creates plasma is dependent on the working fluid, distance between electrodes/transducers but for water it often exhibits a pulse frequency between 1 and 100 Hz, and an applied voltage in a range from 15-30 kV. The voltage accelerates the loose electron towards the positive electrode and positive ions towards the negative electrode before they have the opportunity to recombine. The charged particles absorb energy from the field and accelerate to sufficient velocity that collision with another molecule will, in turn, ionize the impacted molecule, and the ionization process repeats again. The effect creates an exponentially increasing number of ions approaching the electrodes, such that the fluid between the electrodes rapidly becomes electrically conducting due to the high population of ions. When a positive ion reaches the negative electrode, it can release additional electrons due to the high-energy collision. This process is known as secondary electron emission and is a well-documented phenomenon in the field of physics and electronics. The released electrons are then free to move toward the positive electrode, contributing to the flow of electric current, and the fluid gap resistance falls to almost zero. When there is no external resistance to limit the current, a huge current develops between the electrodes, and plasma is formed. The exact clearance between Electrodes/High Energy Source 6 is dependent on the size of the nozzle, the voltage used, and the material used for the electrode, generally, this distance is greater than 0.5 mm. A similar principle occurs when microwave, radio frequency, ultra violate light, or other high-energy transfer methods are used to generate plasma and are considered part of the same embodiment of this disclosure.

The Ceramic Electrode Isolator 5 is pushed into position and retained downstream by the First Stage Separator Inlet 7 located downstream of the Ceramic Electrode Isolator 5. The First Stage Separator Inlet 7 may be part of Reactor 4 or mechanically connected to Reactor 4 and contains a nozzle generally, for example, and without limitation, in the center of the First Stage Separator Inlet 7. The discharge from the First Stage Separator Inlet 7 enters directly into the First Molecular Sieve/Filter 8 and may contain a combination of various atoms, molecules, electrons, anion, ions and other depending on the supercritical fluid contained within the Reactor 4. By way of example and without limitation when the inlet to the Reactor 4 is Supercritical Water (SCW), the First Stage Separator Inlet 7 discharge will include Hydrogen (H and H₂), Oxygen (O and O₂), Hyroxide (OH), and unreacted water (H₂O) molecules. The length of the nozzle between Electrodes/High Energy Source 6 and the First Stage Separator Inlet 7 is dimensionally specified to limit the various atoms, molecules, electrons, anions, ions, and other atomic-based compounds to mix and combine into less preferred relationships and recombine into H₂O, H₂O₂, OH and other molecules and remain at Hydrogen atoms and H₂ molecules. The exact length of the nozzle between Electrodes/High Energy Source 6 and the First Stage Separator Inlet 7, depends on the fluid, flow rate, and nozzle diameter and is often less than the diameter of the nozzle. In general, hydrogen atoms (H) tend to combine more readily with other hydrogen atoms to form hydrogen molecules (H₂) compared to their combination with oxygen atoms (O) to form water molecules (H₂O) and Hydroxide (OH). This difference in reactivity is due to several factors related to the chemical properties of these elements, including, for example, and without limitation:
I. Stability: Hydrogen atoms have a strong tendency to form H₂ molecules because it results in a more stable configuration. In contrast, oxygen atoms are more likely to form O₂ molecules, which are diatomic oxygen molecules, rather than combining with hydrogen atoms.
II. Electronegativity: Oxygen is more electronegative than hydrogen, meaning it attracts electrons more strongly. This makes it less likely for oxygen to readily accept additional electrons from hydrogen atoms to form water molecules.
III. Reaction Barriers: Chemical reactions between hydrogen and oxygen often involve multi-step processes with intermediate species like hydroxide, also known as hydroxyl radicals (OH). These steps can have higher energy barriers compared to the direct combination of two hydrogen atoms to form H₂.
IV. Temperature and Pressure: The rate of chemical reactions, including the combination of atoms, depends on temperature and pressure. Higher temperatures and pressures can favor certain reactions, but even under these conditions, the combination of hydrogen atoms to form H₂ is generally faster than their reaction with oxygen atoms.
V. Overall, the formation of hydrogen molecules (H₂) from hydrogen atoms (H) is a thermodynamically favorable and kinetically faster process compared to the formation of water molecules (H₂O) from hydrogen and oxygen atoms.

The First Molecular Sieve/Filter 8 may be mechanically connected or attached by compressive force to the First Stage Separator Inlet 7 that prevents the discharge from the First Stage Separator Inlet 7 conveying itself around the connection of the First Molecular Sieve/Filter 8 and the First Stage Separator Inlet 7. First Molecular Sieve/Filter 8 contains a pore size that allows the hydrogen to migrate through the body of the First Molecular Sieve/Filter 8 and prevents the remaining contents of the First Stage Separator Inlet 7 from permeating through the First Molecular Sieve/Filter 8. The First Molecular Sieve/Filter 8 has a pore size that is dependent on the material and layers used; however made from a material that is capable of withstanding the supercritical pressure and temperature of the supercritical fluid within the Reactor 4. For example, and without limitation, the material of the First Molecular Sieve/Filter 8 may be manufactured from Steel, Stainless Steel, Inconel, Titanium. Hastelloy, Plastic, Basalt, Zirconium, Zeolite Ceramic, or other suitable materials. The First Molecular Sieve/Filter 8 may be coated by way of example and without limitation, a catalyst such as Pd, Pt or Ru, or other catalytic material that splits Hydrogen molecules into Hydrogen Atoms to allow optimal flow of desired molecules through the First Molecular Sieve/Filter 8 and limit unwanted molecules such as OH permeating through. The substantially pure hydrogen (H and H₂) that has permeated through the First Molecular Sieve/Filter 8 remains contained within Reactor 4 until the substantially pure hydrogen (H and H₂) is conveyed to the First Stage Separated Fluid Discharge 9, where it is removed from the Reactor 4. To support the flow of hydrogen (H and H₂) through the First Molecular Sieve/Filter 8, a valve (not shown) may be placed on the outlet of the First Stage Separated Fluid Discharge 9 to ensure the pressure in the Reactor 4 is greater than the pressure downstream of the First Stage Separated Fluid Discharge 9 thereby providing a pressure drop across the First Molecular Sieve/Filter 8. First Stage Unseparated Discharge 10 depleted of hydrogen (H and H₂) is discharged from the system and used for other purposes (not shown) or disposed of safely (not shown). In another embodiment of the same invention disclosed in FIG. 1A the reactor 4 has magnets (not shown) with negative and/or positive poles installed directly opposite and in close proximity to the First Molecular Sieve/Filter 8 to attract negative and/or positive charged hydrogen atoms to the wall of the First Molecular Sieve/Filter 8.

In another embodiment of the same disclosure as shown in FIG. 1B, the First Stage Unseparated Discharge 10 substantially removed Hydrogen (H and H₂) makes contact with Second Stage Separator Inlet 11. The Second Stage Separator Inlet 11 may be part of the Reactor 4 or mechanically connected to the Reactor 4 and contains a nozzle generally, for example, and without limitation, in the center of the Second Stage Separator Inlet 11. The discharge from the Second Stage Separator Inlet 11 enters directly into the Second Molecular Sieve/Filter 12 and may contain a combination of various atoms, molecules, electrons, anions, ions, and others depending on the supercritical fluid contained within the Reactor 4. By way of example, when the inlet to the Reactor 4 is Supercritical Water (SCW), the Second Stage Separator Inlet 11 discharge will include depleted levels of Hydrogen (H and H₂) and predominantly Oxygen (O and O₂), Hydroxide (OH), and unreacted water (H₂O) molecules. The Second Molecular Sieve/Filter 12 may be mechanically connected or attached by pressure to the Second Stage Separator Inlet 11 that prevents the discharge from the Second Stage Separator Inlet 11 conveying itself around the connection of the Second Molecular Sieve/Filter 12 and the Second Stage Separator Inlet 12. The Second Molecular Sieve/Filter 12 contains a pore size that allows the molecule with the second smallest size and second highest permeability to migrate through the body of the Second Molecular Sieve/Filter 12 and prevents the remaining contents of the Second Stage Separator Inlet 11 from permeating through the Second Molecular Sieve/Filter 12. The Second Stage Molecular Sieve/Filter 12 may be made from a variety of material that is capable of withstanding the supercritical pressure and temperature of the supercritical fluid within Reactor 4. For example, the material of the Second Molecular Sieve/Filter 12 may be manufactured from Steel, Stainless Steel, Inconel, Titanium. Hastelloy, Plastic, Basalt, Zirconium, Zeolite, Ceramic or other materials. The Second Molecular Sieve/Filter 12 may be coated by a catalyst to allow the molecule with the second smallest molecular size to migrate through the Second Molecular Sieve/Filter 12. The substantially pure molecule with the second smallest size that has permeated through the Second Molecular Sieve/Filter 12 remains contained within Reactor 4 until the molecule with the second smallest size is conveyed to the Second Stage Separated Discharge 13, where it is removed from the Reactor 4. To support the flow of molecule with the second smallest size to diffuse through the Second Molecular Sieve/Filter 12 a valve (not shown) may be placed on the outlet of the Second Stage Separated Discharge 13 to ensure the pressure in the Reactor 4 is greater than the pressure downstream of the Second Stage Separated Discharge 13, thereby providing a pressure drop across the Second Molecular Sieve/Filter 12. Second Stage Unseparated Discharge 14 substantially removed both Hydrogen and the molecule with the second smallest size is discharged from the system and used for other purposes (not shown) or disposed of safely (not shown). The remaining atoms, molecules, electrons, anions, ions and others depending on the supercritical fluid contained within the Second Stage Unseparated Discharge 14 substantially removed of both Hydrogen and molecule with the second smallest size may be further separated using a second and Third Molecular Sieve/Filter (not shown) and all included as part of this same disclosure. In another embodiment of the same invention disclosed in FIG. 1B the reactor 4 has magnets (not shown) with negative and/or positive poles installed directly opposite and in close proximity to the First Molecular Sieve/Filter 8 to attract negative and/or positive charged hydrogen atoms to the wall of the First Molecular Sieve/Filter 8.

In another embodiment of the same disclosure and shown in FIG. 1C, the First Stage Unseparated Discharge 10 substantially depleted from Hydrogen is conveyed through a pipe to an Accumulator 15, which is a pressure vessel capable of withholding the required pressure and temperature from the First Stage Unseparated Discharge 10. A stream of Make-up Fluid 16 is conveyed through a pipe to the Accumulator 15, where the additional fluid such as water, methane, ethanol or other replenished volumetric losses created by the removal of Hydrogen by the First Stage Separated Fluid discharge 10. The Inlet Stream 1 that feeds the Compression Device 2 described in the previous embodiment of the same disclosure is discharged from the Accumulator 15, and the process subsequently staged previously disclosed is repeated. In another embodiment of the same invention disclosed in FIG. 1C the reactor 4 has magnets (not shown) with negative and/or positive poles installed directly opposite and in close proximity to the First Molecular Sieve/Filter 8 to attract negative and/or positive charged hydrogen atoms to the wall of the First Molecular Sieve/Filter 8.

In another embodiment of the same disclosure and shown in FIG. 1D, the Second Stage Unseparated Discharge 14 substantially depleted from Hydrogen is conveyed through a pipe to an Accumulator 15, which is a pressure vessel capable of withholding the required pressure and temperature from the Second Stage Unseparated Discharge 14. A stream of Make-up Fluid 16 is conveyed through a pipe to the Accumulator 15, where the additional fluid such as water, methane, ethanol, or other replenished volumetric losses created by the removal of Hydrogen by the Second Stage Separated Fluid Discharge 14. The Inlet Stream 1 that feeds the Compression Device 2 described in the previous embodiment of the same disclosure is discharged from the Accumulator 15, and the process subsequently staged previously disclosed is repeated. In another embodiment of the same invention disclosed in FIG. 1D the reactor 4 has magnets (not shown) with negative and/or positive poles installed directly opposite and in close proximity to the First Molecular Sieve/Filter 8 to attract negative and/or positive charged hydrogen atoms to the wall of the First Molecular Sieve/Filter 8.

In another embodiment of the same disclosure and shown in FIG. 1E, the First Stage Unseparated Discharge 10 substantially depleted from Hydrogen is conveyed through a pipe to an Ejector 17, which is a device well known in the art to create a vacuum that provides a motive force to drive the Make-up Fluid 16 into the Ejector 17 where it becomes pressurized and the additional fluid within the Make-up Fluid 16 such as methane, ethanol or other replenished volumetric losses created by the removal of Hydrogen by the First Stage Separated Fluid Discharge 9. The Inlet Stream 1 that feeds the Compression Device 2 described in the previous embodiment of the same disclosure is discharged from the Ejector 17, and the subsequent process stages previously disclosed are repeated.

In yet another embodiment of the same disclosure shown in FIG. 1F, the Second Stage Unseparated Discharge 14, substantially depleted from Hydrogen, is conveyed through a pipe to an Ejector 17, which is a device well known in the art to create a vacuum that provides a motive force to drive the Make-up Fluid 16 into the Ejector 17 where it becomes pressurized and the additional fluid within the Make-up Fluid 16 for example and without limitation water, methane, ethanol or other replenished volumetric losses created by the removal of Hydrogen by the First Stage Separated Fluid Discharge 10 and Second Stage Separated Discharge 13. The Inlet Stream 1 that feeds the Compression Device 2 described in the previous embodiment of the same disclosure is discharged from the Ejector 17, and the subsequent process stages, as previously disclosed, are repeated.

There are numerous combinations of supercritical fluids, mixed supercritical fluids, and supercritical fluids mixed with non-supercritical fluids contained within a predominantly supercritical fluid flow that are contemplated by this disclosure. For example, when considering water, the following properties may be pertinent:
i. H (Hydrogen Atom): Hydrogen atoms are extremely small, with an approximate diameter on the order of 0.1 angstroms (0.1 Å), which is about 0.00000001 meters.
ii. H₂ (Hydrogen Molecule): The hydrogen molecule (H₂) consists of two hydrogen atoms bonded together. Its molecular size is still very small, with a bond length of about 0.74 angstroms (0.74 Å), or approximately 0.000000074 meters.
iii. O (Oxygen Atom): Oxygen atoms are slightly larger than hydrogen atoms, with an approximate diameter on the order of 0.6 angstroms (0.6 Å), which is about 0.00000006 meters.
iv. O₂ (Oxygen Molecule): The oxygen molecule (O₂) consists of two oxygen atoms bonded together. Its molecular size is approximately twice the size of a single oxygen atom, so it has a bond length of about 1.21 angstroms (1.21 Å), or approximately 0.000000121 meters.
v. OH (Hydroxyl Radical): The hydroxyl radical (OH) is a small radical consisting of one oxygen atom and one hydrogen atom. It has a bond length of approximately 0.96 angstroms (0.96 Å), or about 0.000000096 meters.
vi. H₂O (Water Molecule): The water molecule (H₂O) consists of two hydrogen atoms and one oxygen atom. It has a bond angle of about 104.5 degrees and a bond length of approximately 0.96 angstroms (0.96 Å) for the O—H bonds, or about 0.000000096 meters.

It should be known that the molecular sizes are approximate and can vary depending on factors such as temperature and pressure. Additionally, molecular sizes are typically expressed in terms of bond lengths or van der Waals radii, representing average distances between the nuclei of atoms in a molecule. The items of equipment detailed may be arranged in various configurations.

What is claimed is:

1. A method of splitting a supercritical fluid with plasma into at least one part hydrogen, the method comprises the following steps:
a. providing a reactor filled with at least one supercritical fluid that flows into the reactor from one end thereof;
b. conveying the supercritical fluid of step (a) through a nozzle that contains plasma to form hydrogen;
c. directing the supercritical fluid and hydrogen of step (b) into contact with a First Molecular Sieve/Filter, wherein the hydrogen can selectively diffuse through the filter and non-hydrogen atoms and molecules cannot;
d. directing the diffused hydrogen from one side of the First Molecular Sieve/Filter from the reactor;
e. directing the remaining supercritical fluid depleted from hydrogen atoms and molecules from the opposite side of First Molecular Sieve/Filter of step (d) from the reactor of step (a);
f. repeating steps (a) through (e) to provide a continuous supply of hydrogen.

2. The method of claim 1, wherein step (a) further comprises non-supercritical fluids within the supercritical fluid.

3. The method of claim 1, wherein the plasma from step (b) is created by electrodes with a positive and negative charge and positioned opposite each other within the reactor and supplied with electrical voltage to create the plasma.

4. The method of claim 3, wherein the electrodes are surrounded by a ceramic material with a nozzle within the ceramic material where the electrodes protrude but do not make contact.

5. The method of claim 1, wherein the plasma from step (b) is created by probes emitting microwaves.

6. The method of claim 1, wherein the plasma from step (b) is created by probes emitting high-frequency radio waves.

7. The method of claim 1, wherein the plasma from step (b) is created by probes emitting light waves.

8. The method of claim 1, wherein step (a) further comprises a step of using a compression device to provide the supercritical pressure.

9. The method of claim 1, wherein step (e) the supercritical fluid depleted from hydrogen atoms exits the reactor and is diverted to an accumulator and mixed with Make-Up Fluid.

10. The method of claim 1, wherein step (e) the supercritical fluid depleted from hydrogen atoms exits the reactor and is diverted to an ejector that provides the driving force to draw Make-Up Fluid into the process.

11. A method of splitting a supercritical fluid with plasma into at least one part hydrogen, the method comprises the following steps:
a. providing a reactor filled with at least one supercritical fluid that flows into the reactor from one end thereof;
b. conveying the supercritical fluid of step (a) through a nozzle that contains plasma to form the hydrogen, which may be atoms and/or molecules;
c. directing the supercritical fluid and hydrogen of step (b) into contact with a First Molecular Sieve/Filter, wherein the hydrogen selectively diffuses through the Molecular Sieve/Filter and non-hydrogen atoms and molecules cannot;
d. directing the remaining supercritical fluid depleted from hydrogen atoms and molecules from the opposite side of the First Molecular Sieve/Filter of step (d) and into contact with the Second Molecular Sieve/Filter, wherein the next smallest molecule after hydrogen diffuse through the Second Molecular Sieve/Filter;
e. directing the remaining supercritical fluid depleted from hydrogen and the next smallest molecule after hydrogen from the opposite side of the Second Molecular Sieve/Filter of step (d) from the reactor of step (a);
f. repeating steps (a) through (e) to provide a continuous supply of hydrogen and the next smallest molecule after hydrogen.

12. The method of claim 10, wherein step (a) further comprises non-supercritical fluids within the supercritical fluid.

13. The method of claim 10, wherein the plasma from step (b) is created by electrodes with a positive and negative charge and positioned opposite each other within the reactor and supplied with electrical voltage to create the plasma.

14. The method of claim 12, wherein the electrodes are surrounded by a ceramic material with a nozzle within the ceramic material where the electrodes protrude but do not make contact.

15. The method of claim 10, wherein the plasma from step (b) is created by probes emitting microwaves.

16. The method of claim 10, wherein the plasma from step (b) is created by probes emitting high-frequency radio waves.

17. The method of claim 10, wherein the plasma from step (b) is created by probes emitting light waves.

18. The method of claim 10, wherein step (a) further comprises using a compression device to provide the supercritical pressure.

19. The method of claim 10, wherein step (e) the supercritical fluid depleted from hydrogen exits the reactor and is diverted to an accumulator and mixed with Make-Up Fluid.

20. The method of claim 10, wherein step (e) the supercritical fluid depleted from hydrogen exits the reactor and is diverted to an ejector that provides the driving force to draw Make-Up Fluid into the process.
